(19) United States
(12) Patent Application Publication
(10) Pub. No.: US 2023/0330822 A1
(43) Pub. Date: Oct. 19, 2023

(54) FASTENING TOOL

(71) Applicant: MAX CO., LTD., Tokyo (JP)

(72) Inventors: Yusuke OSAWA, Tokyo (JP); Kazuya TAKEUCHI, Tokyo (JP)

(73) Assignee: MAX CO., LTD., Tokyo (JP)

(21) Appl. No.: 18/133,924

(22) Filed: Apr. 12, 2023

(30) Foreign Application Priority Data
Apr. 15, 2022 (JP) 2022-067707

(51) Int. Cl. B25B 21/00; B25B 23/06

(52) U.S. Cl. CPC B25B 21/007; B25B 21/008; B25B 23/06

(57) ABSTRACT

A fastening tool includes a bit holding portion configured to hold a driver bit engageable with a screw and rotatable in a circumferential direction of the driver bit and movable in an axial direction of the driver bit, a motor configured to move the bit holding portion in the axial direction, a controller configured to control output of the motor to control a movement speed of the bit holding portion in the axial direction, and a motor state detector configured to detect a state of the motor. The controller is configured to control the movement speed of the bit holding portion based on the state of the motor when the screw engaged with the driver bit is fastened to a fastening target.

### CROSS-REFERENCE TO RELATED APPLICATIONS

This application is based upon and claims the benefit of priority from prior Japanese patent application No. 2022-067707, filed on Apr. 15, 2022, the entire contents of which are incorporated herein by reference.

### TECHNICAL FIELD

The present invention relates to a fastening tool in which a driver bit is engaged with a screw, the screw is pressed against a fastening target by the driver bit, and the driver bit is rotated to be screwed.

### BACKGROUND ART

There is known a tool referred to as a portable driving machine that uses an air pressure of compressed air supplied from an air compressor or a combustion pressure of gas to sequentially punch a coupling stopper loaded in a magazine from a tip of a driver guide.

In a tool in which a bit is rotated to fasten a screw and is moved in a direction in which the screw is driven, in the related art, a pneumatic screw driving machine in which a bit is rotated by an air motor and moved by an air pressure in a direction in which the screw is driven is proposed (for example, refer to JP5262461B).

Further, a screw driving machine that compresses a spring by a driving force of a motor for rotating a driver bit and drives a screw by moving the driver bit in an axial direction by biasing of the spring is proposed (for example, refer to JP6197547B).

As an operation using a screw driving machine, an operation of fastening a screw to a member in which a gypsum board is placed on a base of steel sheet may be performed. However, in a configuration in which a driver bit is moved in an axial direction by biasing of the spring to drive a screw, it is difficult to control a movement speed of a bit holding portion. For example, even in a stage where the screw cannot drill a hole in the steel sheet by the biasing of the spring, the driver bit continues to move forward by the biasing of the spring, and therefore, the fastening tool is floated by a reaction force of a force of the driver bit pressing a fastening target via the screw.

The present disclosure is made to solve such a problem, and an object of the present disclosure is to provide a fastening tool capable of controlling the movement speed of the bit holding portion.

### SUMMARY OF INVENTION

According to an aspect of the disclosure, a fastening tool includes a bit holding portion configured to hold a driver bit engageable with a screw and rotatable in a circumferential direction of the driver bit and movable in an axial direction of the driver bit, a motor configured to move the bit holding portion in the axial direction, a controller configured to control output of the motor to control a movement speed of the bit holding portion in the axial direction, and a motor state detector configured to detect a state of the motor. The controller is configured to control the movement speed of the bit holding portion based on the state of the motor when the screw engaged with the driver bit is fastened to a fastening target.

In the present disclosure, the movement speed of the bit holding portion is controlled based on the state of the motor when the screw engaged with the driver bit is fastened to the fastening target.

According to another aspect of the disclosure, a fastening tool includes a bit holding portion configured to hold a driver bit engageable with a screw and rotatable in a circumferential direction of the driver bit and movable in an axial direction of the driver bit, a first motor configured to rotate the bit holding portion in the circumferential direction, a second motor configured to move the bit holding portion in the axial direction, a controller configured to control output of the first motor to control a rotation speed of the bit holding portion, and control output of the second motor to control a movement speed of the bit holding portion, and a first motor state detector configured to detect a state of the first motor. The controller is configured to control the movement speed of the bit holding portion based on the state of the first motor detected by the first motor detector when the screw engaged with the driver bit is fastened to a fastening target.

In the present disclosure, the movement speed of the bit holding portion is controlled based on the state of the first motor when the screw engaged with the driver bit is fastened to the fastening target.

In the present disclosure, the movement speed of the bit holding portion may be controlled based on the states of the motor for moving the bit holding portion in the axial direction and the first motor for rotating the bit holding portion.

### BRIEF DESCRIPTION OF DRAWINGS

FIG. 1A is a cross-sectional view showing an example of an internal structure of a fastening tool of the present embodiment.

FIG. 1B is a sectional plan view showing an example of the internal structure of the fastening tool of the present embodiment.

FIG. 1C is an exploded perspective view showing an example of the internal structure of the fastening tool of the present embodiment.

FIG. 2A is a perspective view showing an example of a main configuration of the fastening tool of the present embodiment.

FIG. 2B is a perspective view showing an example of the main configuration of the fastening tool of the present embodiment.

FIG. 3A is a cross-sectional perspective view showing an example of the main configuration of the fastening tool of the present embodiment.

FIG. 3B is a cross-sectional perspective view showing an example of the main configuration of the fastening tool of the present embodiment.

FIG. 4 is a perspective view showing an example of a screw feed portion and a nose portion of the present embodiment.

FIG. 5 is a block diagram showing an example of the fastening tool of the present embodiment.

FIG. 6 is a perspective view showing an example of a setting portion.

FIG. 7A is a flowchart showing an example of an operation of the fastening tool of the present embodiment.

FIG. 7B is a flowchart showing an example of the operation of the fastening tool of the present embodiment.

FIG. 8A is a graph showing a relation between rotation speeds of a bit rotation motor and a bit movement motor.

FIG. 8B is a graph showing the relation between the rotation speeds of the bit rotation motor and the bit movement motor.

FIG. 9A is a cross-sectional view showing a fastened state of a screw.

FIG. 9B is a cross-sectional view showing the fastened state of the screw.

FIG. 9C is a cross-sectional view showing the fastened state of the screw.

FIG. 10A is a flowchart showing another example of the operation of the fastening tool of the present embodiment.

FIG. 10B is a flowchart showing another example of the operation of the fastening tool of the present embodiment.

FIG. 11A is a graph showing the relation between the rotation speeds of the bit rotation motor and the bit movement motor.

FIG. 11B is a graph showing the relation between the rotation speeds of the bit rotation motor and the bit movement motor.

FIG. 11C is a graph showing the relation between the rotation speeds of the bit rotation motor and the bit movement motor.

FIG. 12A is a flowchart showing another example of the operation of the fastening tool of the present embodiment.

FIG. 12B is a flowchart showing another example of the operation of the fastening tool of the present embodiment.

FIG. 13 is a graph showing the relation between the rotation speeds of the bit rotation motor and the bit movement motor.

### DESCRIPTION OF EMBODIMENTS

Hereinafter, embodiments of a fastening tool of the present disclosure will be described with reference to each drawing.

Configuration Example of Fastening Tool of the Present Embodiment

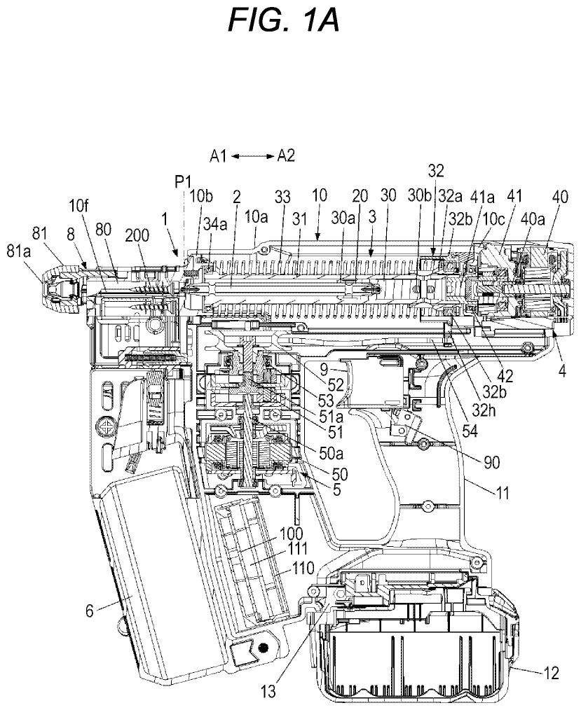

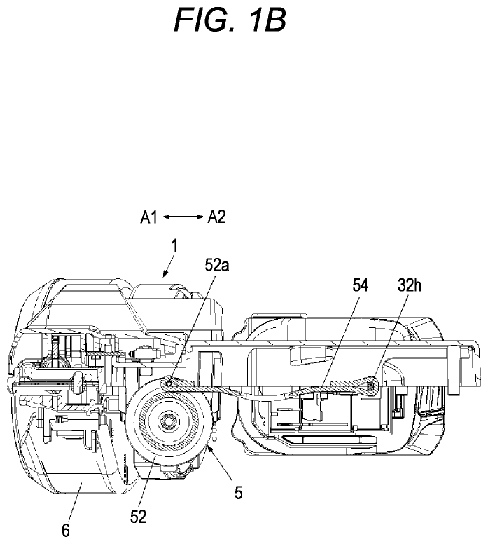

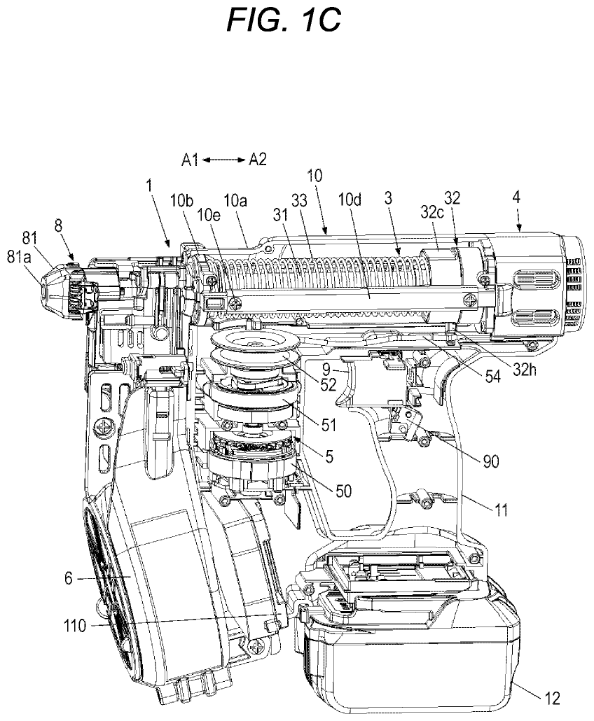

FIG. 1A is a cross-sectional view showing an example of an internal structure of a fastening tool of the present embodiment, FIG. 1B is a sectional plan view showing an example of the internal structure of the fastening tool of the present embodiment, and FIG. 1C is an exploded perspective view showing an example of the internal structure of the fastening tool of the present embodiment.

A fastening tool 1 of the present embodiment includes a bit holding portion 3 that rotatably and movably holds a driver bit 2 in an axial direction, a first driving portion 4 that rotates the driver bit 2 held by the bit holding portion 3, and a second driving portion 5 that moves the driver bit 2 held by the bit holding portion 3 in the axial direction.

In addition, the fastening tool 1 includes a screw storage portion 6 in which a screw 200 is stored, a screw feed portion 7 described later that feeds the screw stored in the screw storage portion 6, and a nose portion 8 that is pressed against a fastening target into which the screw 200 is fastened and from which the screw 200 is injected.

Further, the fastening tool 1 includes a tool body 10 and a handle 11. The fastening tool 1 also includes a battery attachment portion 13 to which a battery 12 is detachably attached to an end portion of the handle 11.

In the fastening tool 1, the tool body 10 extends in one direction along an axial direction of the driver bit 2 indicated by arrows A1 and A2, and the handle 11 extends in another direction intersecting the extending direction of the tool body 10. In the fastening tool 1, the direction in which the tool body 10 extends, that is, the axial direction of the driver bit 2 indicated by the arrows A1 and A2 is defined as a front-rear direction. In addition, in the fastening tool 1, the direction in which the handle 11 extends is defined as an up-down direction. Further, in the fastening tool 1, a direction orthogonal to the extending direction of the tool body 10 and the extending direction of the handle 11 is defined as a left-right direction.

The first driving portion 4 is provided on a rear side, which is one side of the tool body 10, with the handle 11 interposed therebetween. The second driving portion 5 is provided on a front side, which is the other side of the tool body 10, with the handle 11 interposed therebetween.

In the screw storage portion 6, a plurality of screws 200 are connected by a connecting band, and a connection screw wound in a spiral shape is stored.

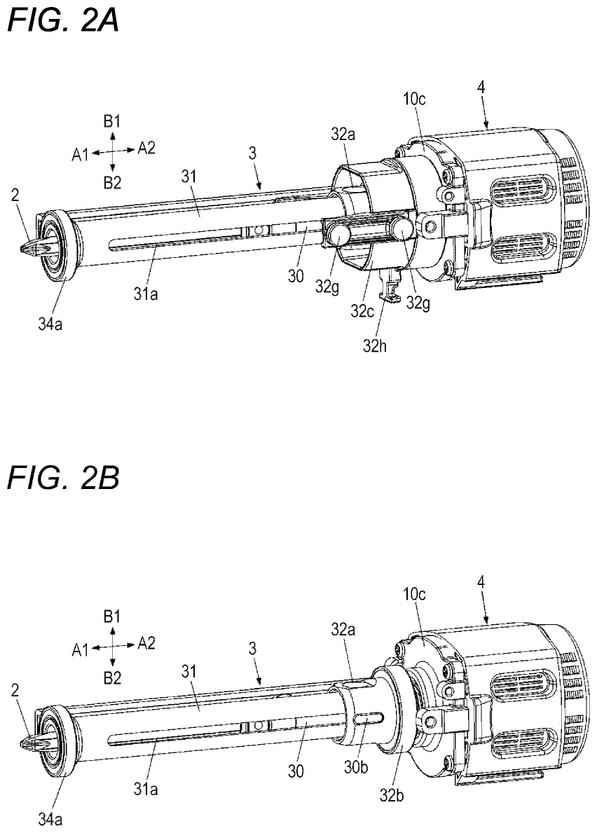

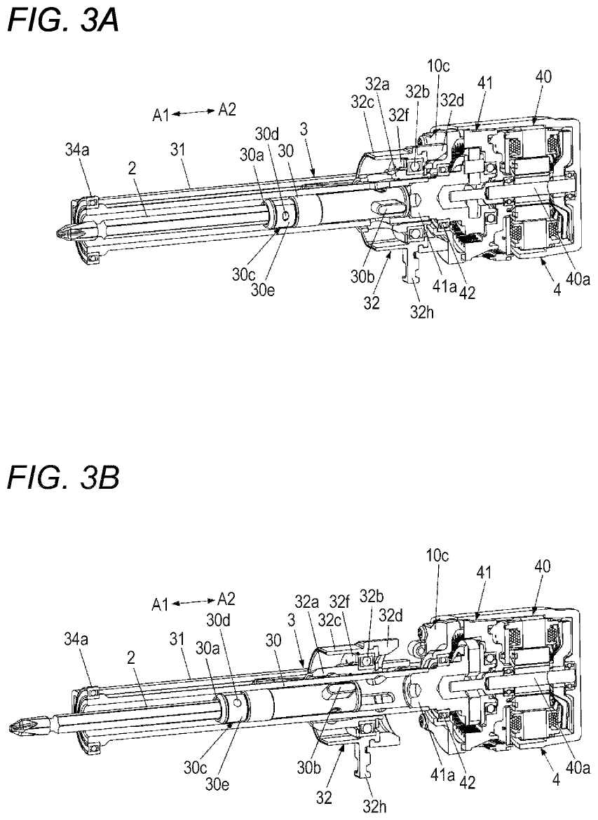

FIGS. 2A and 2B are perspective views showing examples of a main configuration of the fastening tool of the present embodiment, and FIGS. 3A and 3B are cross-sectional perspective views showing examples of the main configuration of the fastening tool of the present embodiment. Next, the bit holding portion 3 and the first driving portion 4 will be described with reference to each drawing.

The bit holding portion 3 includes a holding member 30 that detachably holds the driver bit 2, a rotation guide member 31 that supports the holding member 30 movably in the front-rear direction indicated by the arrows A1 and A2 along the axial direction of the driver bit 2 and rotates together with the holding member 30, a moving member 32 that moves the holding member 30 in the front-rear direction along the rotation guide member 31, and a biasing member 33 that biases the moving member 32 in the rear direction indicated by the arrow A2.

The holding member 30 is formed of, for example, a cylindrical member having an outer diameter slightly smaller than an inner diameter of the rotation guide member 31 and inserted into the rotation guide member 31. In the holding member 30, an opening 30a having a shape matching a cross-sectional shape of the driver bit 2 is provided on a front-end portion along the axial direction of the driver bit 2. The holding member 30 includes a detachable holding mechanism 30c that detachably holds the driver bit 2 in the opening 30a. In the holding member 30, the opening 30a is exposed to the inside of the rotation guide member 31, and the driver bit 2 is detachably inserted into the opening 30a.

The detachable holding mechanism 30c includes a ball 30d exposed in the opening 30a and a spring 30e that biases the ball 30d in a direction in which the ball 30d is exposed in the opening 30a. The spring 30e is an annular leaf spring and is fitted to an outer periphery of the holding member 30.

In the detachable holding mechanism 30c, the ball 30d biased by the spring 30e is fitted into a groove portion of the driver bit 2 so that the driver bit 2 is prevented from being carelessly removed from the holding member 30. In addition, when a force equal to or greater than a predetermined force is applied in a direction in which the driver bit 2 is pulled out from the holding member 30, the driver bit 2 may be pulled out from the holding member 30 by retracting the ball 30d while deforming the annular spring 30e.

The rotation guide member 31 extends along the extending direction of the tool body 10, that is, the front-rear direction indicated by the arrows A1 and A2 along the axial direction of the driver bit 2. The rotation guide member 31 has a cylindrical shape in which the holding member 30 is accommodated, and a front end portion is rotatably supported by a front frame 10b provided on a front side of a case 10a constituting an exterior of the tool body 10 via a bearing 34a as an example of a bearing. In addition, a rear end portion of the rotation guide member 31 is connected to the first driving portion 4.

In the rotation guide member 31, groove portions 31a extending in the front-rear direction indicated by the arrows A1 and A2 along the axial direction of the driver bit 2 are formed at two positions of a circumferential surface facing each other in a radial direction. The rotation guide member 31 penetrates the holding member 30 in the radial direction and is connected to the holding member 30 via a connection member 30b protruding from both sides of the holding member 30 by the connection member 30b being inserted in the groove portions 31a.

The connection member 30b is formed of a cylindrical member having an elliptical cross-sectional shape, and a longitudinal direction of the elliptical shape is a direction along an extending direction of the groove portion 31a parallel to the axial direction of the driver bit 2 indicated by the arrows A1 and A2. In addition, a lateral direction of the elliptical shape of the connection member 30b is a direction orthogonal to the extending direction of the groove portion 31a indicated by arrows B1 and B2, that is, a direction along a rotation direction of the rotation guide member 31. A width of the connection member 30b in the lateral direction of the elliptical shape, that is, a width of the rotation guide member 31 along the rotation direction is slightly smaller than a width of the groove portion 31a along the same direction.

Accordingly, the connection member 30b inserted into the groove portions 31a is supported by the groove portions 31a to be movable along the axial direction of the rotation guide member 31. In addition, movement of the connection member 30b along the rotation direction with respect to the rotation guide member 31 is restricted between one side surface and the other side surface of the groove portion 31a along the extending direction of the groove portion 31a. Accordingly, when the rotation guide member 31 rotates, the connection member 30b is pressed by one side surface or the other side surface of the groove portion 31a according to the rotation direction of the rotation guide member 31 and receives a force in a circumferential direction, which is the rotation direction, from the rotation guide member 31.

Therefore, when the rotation guide member 31 rotates, the connection member 30b is pressed by the groove portions 31a of the rotation guide member 31, and thus the holding member 30 rotates together with the rotation guide member 31. In addition, the connection member 30b is guided by the groove portions 31a of the rotation guide member 31, and the holding member 30 moves in the front-rear direction along the axial direction of the driver bit 2.

The moving member 32 includes a first moving member 32a that rotates together with the holding member 30 and moves the holding member 30 in the front-rear direction along the rotation guide member 31, a second moving member 32c that is supported by the first moving member 32a via a bearing 32b and presses the first moving member 32a via the bearing 32b, and a buffer member 32d attached to a rear side of the second moving member 32c.

The first moving member 32a is formed of, for example, a cylindrical member having an inner diameter slightly greater than an outer diameter of the rotation guide member 31 and inserted outside the rotation guide member 31. The first moving member 32a is connected to the holding member 30 via the connection member 30b protruding from the groove portion 31a of the rotation guide member 31 and is thereby supported movably along the axial direction of the rotation guide member 31.

The bearing 32b is an example of a bearing and is inserted between an outer periphery of the first moving member 32a and an inner periphery of the second moving member 32c. The first moving member 32a constitutes a bearing inner ring holding member that holds an inner ring of the bearing 32b, and the second moving member 32c constitutes a bearing outer ring holding member that holds an outer ring of the bearing 32b. The inner ring of the bearing 32b is supported on the outer periphery of the first moving member 32a so as not to be movable in the rotation direction and the axial direction, and the outer ring of the bearing 32b is supported on the inner periphery of the second moving member 32c so as not to be movable in the rotation direction and the axial direction.

As a result, the second moving member 32c is connected to the first moving member 32a via the bearing 32b in a state in which the movement in the front-rear direction along the axial direction is restricted. In addition, the second moving member 32c rotatably supports the first moving member 32a via the bearing 32b.

Therefore, when the second moving member 32c moves in the front-rear direction along the axial direction, the first moving member 32a is pressed by the second moving member 32c via the bearing 32b and moves in the front-rear direction along the axial direction together with the second moving member 32c. The first moving member 32a is rotatable to the second moving member 32c which is not rotatable to the rotation guide member 31.

The biasing member 33 is formed of a coil spring in this example, is inserted between the front frame 10b provided on a front side of a case 10a of the tool body 10 and the second moving member 32c of the moving member 32 on an outer side of the rotation guide member 31, and comes into contact with a spring seat 32f disposed to come into contact with an end surface of the outer ring of the bearing 32b. The biasing member 33 is compressed when the moving member 32 moves in the front direction indicated by the arrow A1, and applies a force to the moving member 32 to press the moving member 32 in the rear direction indicated by the arrow A2.

The first driving portion 4 includes a speed reducer 41 and a bit rotation motor 40 driven by electricity supplied from the battery 12. The bit rotation motor 40 is an example of a first motor, a shaft 40a of the bit rotation motor 40 is connected to the speed reducer 41, and a shaft 41a of the speed reducer 41 is connected to the rotation guide member 31. The first driving portion 4 has a configuration in which the speed reducer 41 uses a planetary gear, and the bit rotation motor 40 is disposed coaxially with the rotation guide member 31, the holding member 30, and the driver bit 2 held by the holding member 30.

In the first driving portion 4, the bit rotation motor 40 and the speed reducer 41 are attached to a rear frame 10c provided on a rear side of the case 10a of the tool body 10, and the shaft 41a of the speed reducer 41 is supported by the rear frame 10c via the bearing 42. The rear end portion of the rotation guide member 31 is connected to the shaft 41a of the speed reducer 41 and the shaft 41a is supported by the rear frame 10c via the bearing 42, and thus the rotation guide member 31 is rotatably supported via the bearing 42, which is an example of a bearing.

The bit holding portion 3 and the first driving portion 4 are integrally assembled by connecting the front frame 10b and the rear frame 10c by a coupling member 10d extending in the front-rear direction, and the front frame 10b is fixed to the case 10a of the tool body 10 by a screw 10e.

In the bit holding portion 3, the front end portion of the rotation guide member 31 is supported by the front frame 10b fixed to the front side of the case 10a of the tool body 10 via the bearing 34a, and the rear end portion of the rotation guide member 31 is supported by the rear frame 10c fixed to the rear side of the case 10a via the shaft 41a of the speed reducer 41 and the bearing 42. Therefore, in the bit holding portion 3, the rotation guide member 31 is rotatably supported by the tool body 10.

Accordingly, the first driving portion 4 causes the bit rotation motor 40 to rotate the rotation guide member 31. When the rotation guide member 31 rotates, the connection member 30b is pressed by the groove portions 31a of the rotation guide member 31, and thus the holding member 30 holding the driver bit 2 rotates together with the rotation guide member 31.

In the bit holding portion 3, guide members 32g are provided on the second moving member 32c. When the guide member 32g is guided by the coupling member 10d, the second moving member 32c is movable in the front-rear direction indicated by the arrows A1 and A2 along the axial direction of the driver bit 2 and is restricted from rotating following the rotation guide member 31.

Next, the second driving portion 5 will be described with reference to each drawing. The second driving portion 5 includes a speed reducer 51 and a bit movement motor 50 driven by the electricity supplied from the battery 12. The bit movement motor 50 is an example of a motor and a second motor, a shaft 50a of the bit movement motor 50 is connected to the speed reducer 51, and a shaft 51a of the speed reducer 51 is connected to a pulley 52, which is an example of a transmission member. In the second driving portion 5, the pulley 52 is supported by the tool body 10 via a bearing 53. In the second driving portion 5, the shaft 50a of the bit movement motor 50 is disposed along an extending direction of the handle 11.

In the second driving portion 5, one end of a linear wire 54 as an example of the transmission member is connected to the pulley 52, and the wire 54 is wound around the pulley 52 by rotation of the pulley 52. The other end of the wire 54 is connected to a wire connection portion 32h provided on the second moving member 32c of the moving member 32.

Accordingly, the second driving portion 5 causes the bit movement motor 50 to rotate the pulley 52 to wind up the wire 54, thereby causing the second moving member 32c to move in the front direction indicated by the arrow A1. In the bit holding portion 3, when the second moving member 32c moves in the front direction, the first moving member 32a is pressed via the bearing 32b and moves in the front direction along the axial direction together with the second moving member 32c. When the first moving member 32a moves in the front direction, the holding member 30 connected to the first moving member 32a via the connection member 30b moves in the front direction, and the driver bit 2 held by the holding member 30 moves in the front direction indicated by the arrow A1.

The second driving portion 5 is disposed to be offset to one side with respect to a substantial center in the left-right direction of the fastening tool 1 so that a tangential direction of a portion of the pulley 52 around which the wire 54 is wound is along an extending direction of the rotation guide member 31. Further, in order to move the driver bit 2 by a predetermined amount, a diameter and the like of the pulley 52 are set so that the wire 54 is not wound around the pulley 52 in an overlapping manner when the pulley 52 winds the wire 54.

Accordingly, a relation between a rotation amount of the bit movement motor 50 and a movement amount of the holding member 30 is a one-to-one relation over an entire movable range of the holding member 30, and the movement amount of the holding member 30 along the axial direction of the rotation guide member 31 may be controlled by controlling the rotation amount of the bit movement motor 50. That is, it is possible to control a movement amount of the driver bit 2 attached to the holding member 30 by controlling the rotation amount of the bit movement motor 50.

It is also possible to increase a movement speed of the driver bit 2 according to a rotation speed of the bit movement motor 50. Therefore, it is possible to shorten a time until the screw 200 is pressed against the fastening target by the driver bit 2.

The wire 54 is flexible enough to be wound around the pulley 52, and cannot thus press the second moving member 32c to move the moving member 32 rearward. Therefore, the biasing member 33 is provided which is compressed when the moving member 32 moves in the front direction indicated by the arrow A1 and applies a force to the moving member 32 to press the moving member 32 in the rear direction indicated by the arrow A2. As a result, the wire 54 is wound by the pulley 52, and the driver bit 2 moves forward so that the driver bit 2 after the forward movement may be moved backward.

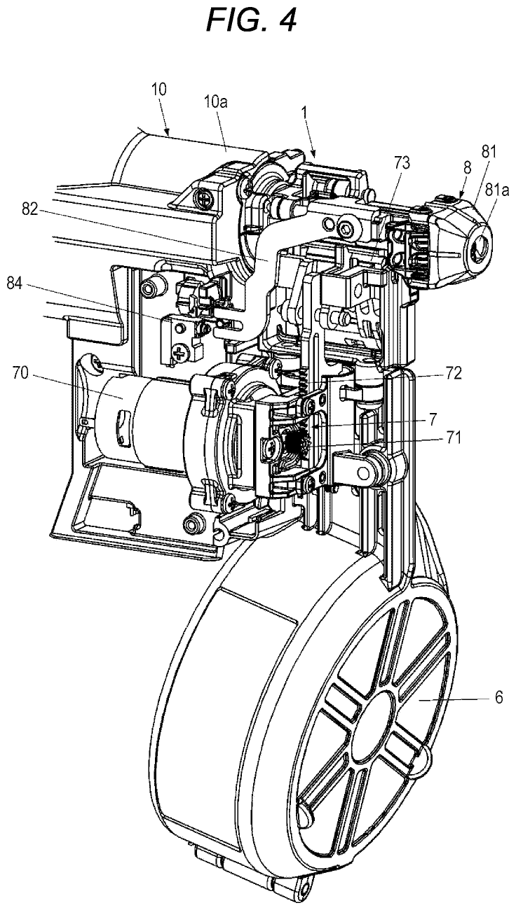

FIG. 4 is a perspective view showing an example of a screw feed portion and a nose portion according to the present embodiment. Next, the screw feed portion 7 and the nose portion 8 will be described with reference to each drawing. The screw feed portion 7 includes a screw feed motor 70, a pinion gear 71 attached to a shaft of the screw feed motor 70 via a speed reducer, a rack gear 72 engaged with the pinion gear 71, and an engagement portion 73 connected to the rack gear 72 and engaged with the connection screw fed from the screw storage portion 6.

In the screw feed portion 7, the rack gear 72 is supported to be movable in the up-down direction along a feeding direction of the connection screw. In the screw feed portion 7, when the screw feed motor 70 normally and reversely rotates, the engagement portion 73 engaged with the connection screw reciprocates in the up-down direction, and the connection screw is fed. The screw feed portion 7 may reciprocate the engagement portion 73 by a driving portion that linearly moves by a combination of a biasing unit and an electromagnetic force such as a solenoid.

The nose portion 8 includes an injection passage 80 through which the driver bit 2 passes when the screw 200 is supplied from the screw feed portion 7. The nose portion 8 also includes a contact member 81 that has an injection port 81a communicating with the injection passage 80 and comes into contact with the fastening target. The nose portion 8 further includes a contact arm 82 that moves in the front-rear direction in conjunction with the contact member 81.

In the nose portion 8, the contact member 81 is movably supported in the front-rear direction indicated by the arrows A1 and A2, and the contact arm 82 moves in the front-rear direction in conjunction with the contact member 81. In the nose portion 8, the contact member 81 is biased in the front direction by a biasing member (not shown), and the contact member 81 which is pressed against the fastening target and moves rearward is biased by the biasing member to move in the front direction.

The fastening tool 1 includes a contact switch portion 84 that operates by being pressed by the contact arm 82. When the contact member 81 is pressed against the fastening target and moves rearward, the contact arm 82 moves reward, and thus the contact switch portion 84 is pressed by the contact arm 82, whereby presence or absence of the operation is switched. In this example, a state where the contact switch portion 84 is not pressed by the contact arm 82 and is not operated is referred to as an OFF state of the contact switch portion 84, and a state where the contact switch portion 84 is pressed by the contact arm 82 and is operated is referred to as an ON state of the contact switch portion 84.

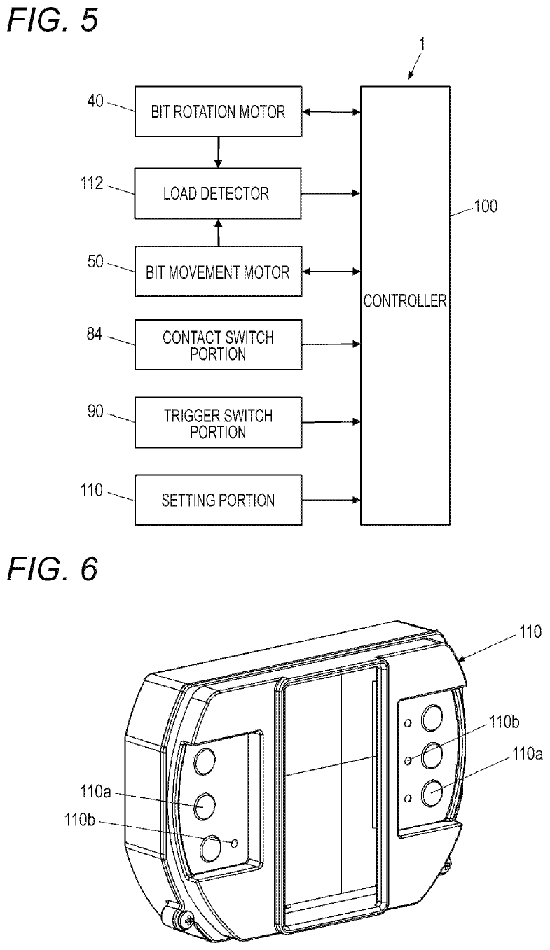

FIG. 5 is a block diagram showing an example of the fastening tool of the present embodiment. Next, a configuration related to control and operation of the fastening tool 1 will be described with reference to each drawing.

The fastening tool 1 includes a trigger 9 that receives an operation and a trigger switch portion 90 that operates in response to the operation of the trigger 9. As shown in FIG. 1A and the like, the trigger 9 is provided on a front side of the handle 11 and is operable by fingers of a hand gripping the handle 11. The trigger switch portion 90 is operated by being pressed by the trigger 9.

The trigger switch portion 90 is pressed by the trigger 9 to switch the presence or absence of the operation, and in this example, a state where the trigger 9 is not operated and the trigger switch portion 90 is not pressed by the trigger 9 and is not operated is referred to as an OFF state of the trigger switch portion 90, and a state where the trigger 9 is operated and the trigger switch portion 90 is pressed by the trigger 9 and is operated is referred to as an ON state of the trigger switch portion 90.

The fastening tool 1 includes a controller 100 that controls the first driving portion 4, the second driving portion 5, and the screw feed portion 7 based on output of the trigger switch portion 90 that is operated by the operation of the trigger 9 and the contact switch portion 84 that is operated by being pressed by the contact member 81. The controller 100 is configured by a substrate on which various electronic components are mounted, and as shown in FIG. 1A, is stored in a substrate storage portion 111 provided on a back side of the screw storage portion 6 between the screw storage portion 6 and the handle 11.

The controller 100 controls whether to drive the bit movement motor 50 of the second driving portion 5 and the bit rotation motor 40 of the first driving portion 4 based on a combination of the ON and the OFF of the contact switch portion 84 and the ON and the OFF of the trigger switch portion 90. The controller 100 includes a motor state detector that detects the state of the bit movement motor 50, and controls the movement speed of the bit holding portion 3 based on the state of the bit movement motor 50 when the screw 200 engaged with the driver bit 2 is fastened to the fastening target. In addition, the controller 100 includes a first motor state detector that detects the state of the bit rotation motor 40, and controls the movement speed of the bit holding portion 3 based on the state of the bit rotation motor 40 when the screw 200 engaged with the driver bit 2 is fastened to the fastening target. The motor state detector and the first motor state detector may be a detector that detects the number of rotations (rotation speed) and the like of the bit movement motor 50 and the bit rotation motor 40 independently of the controller 100.

As described above, the fastening tool 1 includes the first driving portion 4 which rotates the driver bit 2 held by the holding member 30 in the bit holding portion 3 by the driving of the bit rotation motor 40. The fastening tool 1 also includes the second driving portion 5 which moves the driver bit 2 held by the holding member 30 in the bit holding portion 3 in the front-rear direction along the axial direction by the driving of the bit movement motor 50.

In the fastening tool 1, when the bit movement motor 50 rotates in a predetermined direction, the driver bit 2 held by the holding member 30 in the bit holding portion 3 moves in the front direction indicated by the arrow A1 (moves forward). In the fastening tool 1, when the bit rotation motor 40 rotates in a predetermined direction, the driver bit 2 rotates in a direction in which the screw 200 is fastened.

The fastening tool 1 moves the driver bit 2 forward by the rotation of the bit movement motor 50 to engage the driver bit 2 with the recess 200a of the screw 200, and moves the screw 200 in the front direction to press the screw 200 against the fastening target.

In addition, the fastening tool 1 rotates the driver bit 2 by the rotation of the bit rotation motor 40 in a direction in which the screw 200 is fastened to fasten the screw 200 engaged with the driver bit 2 to the fastening target.

Further, the fastening tool 1 rotates the bit movement motor 50 in conjunction with the rotation of the bit rotation motor 40 to move the driver bit 2 forward following the fastening of the screw 200.

Therefore, the controller 100 controls the movement amount (forward movement amount) of the driver bit 2 by controlling the rotation amount of the bit movement motor 50. The controller 100 controls a stop position along the axial direction of the driver bit 2 by controlling the movement amount of the driver bit 2.

In addition, the controller 100 controls a rotation speed of the bit rotation motor 40 and the rotation speed of the bit movement motor 50 to move the driver bit 2 forward following the fastening of the screw 200.

When the driver bit 2 is rotated by the rotation of the bit rotation motor 40 in the direction in which the screw 200 is fastened, the screw 200 engaged with the driver bit 2 is fastened to the fastening target, and thus the screw 200 moves (moves forward) along the axial direction. A movement amount (movement speed) along the axial direction of the screw 200 in accordance with the rotation of the screw 200 is estimated from a lead angle of the screw 200 and the rotation amount and the rotation speed of the bit rotation motor 40.

The controller 100 rotates the bit movement motor 50 at a predetermined rotation speed so that the movement amount (movement speed) along the axial direction of the driver bit 2 follows the movement amount (movement speed) of the screw 200.

The fastening tool 1 moves the screw 200 in the front direction and presses the screw 200 against the fastening target so that a tip of the screw 200 forms a hole on a surface of the fastening target. However, when the fastening target is a steel sheet, the hole is less likely to be drilled in comparison with a case where the fastening target is wood, gypsum, or the like. When an operation of moving the screw 200 in the front direction to drill the hole in a fastening target in which a hole is not easily drilled such as a steel sheet is started, the screw 200 is in a state of being difficult to move forward until the hole is drilled in the steel sheet and a portion of the screw 200 where a screw thread is formed reaches the steel sheet, and thus a load applied in the axial direction of the driver bit 2 is increased. When the screw 200 is moved forward to drill a hole in the fastening target, if the load applied in the axial direction of the driver bit 2 is increased, a reaction force of a force by which the driver bit 2 presses the fastening target via the screw 200 increases, and the fastening tool 1 may float from the fastening target.

Therefore, when the screw 200 is moved in the front direction by the rotation of the bit movement motor 50 and the hole is drilled in the fastening target by the screw 200, for example, when the fastening target is a steel sheet, the controller 100 controls the rotation speed of the bit movement motor 50 in a case where the load applied in the axial direction of the driver bit 2 is high, and prevents the floating of the fastening tool 1 by the reaction force of the force by which the driver bit 2 presses the fastening target via the screw 200.

That is, in the fastening tool 1, the tip of the screw 200 is pressed against the fastening target by the operation of moving (moving forward) the driver bit 2 in the axial direction. However, in the case of the fastening target in which a hole is not easily drilled such as a steel sheet, the load applied in the axial direction of the driver bit 2 is increased and the screw 200 is in the state of being difficult to move forward, and thus a load when moving (moving forward) the driver bit 2 in the axial direction is increased. Therefore, during the operation of drilling the hole by the screw 200 in the fastening target in which a hole is not easily drilled such as a steel sheet, the movement amount (forward movement amount) along the axial direction of the driver bit 2 is decreased as compared with a case where the screw 200 is fastened to a normal fastening target such as wood or gypsum.

When the movement amount (forward movement amount) along the axial direction of the driver bit 2 is decreased, since the rotation speed of the bit movement motor 50 decreases, during an operation in which the screw 200 is moved forward to be pressed against the fastening target in which a hole is not easily drilled such as a steel sheet to drill a hole, a reduction amount of the rotation speed of the bit movement motor 50 is increased as compared with a case where the screw 200 is fastened to the normal fastening target such as wood or gypsum.

On the other hand, in the case of the fastening target in which a hole is not easily drilled such as a steel sheet, since the screw 200 is in a state of idling until the tip of the screw 200 drills the hole in the steel sheet, a load applied in the rotation direction of the driver bit 2 is reduced, and the rotation speed of the bit rotation motor 40 is not reduced as compared with a case where the tip of the screw 200 drills the hole in the fastening target and is fastened to the fastening target.

Accordingly, in the operation of moving the screw 200 engaged with the driver bit 2 forward to drill the hole in the fastening target, the rotation speed (rotation amount) of the bit rotation motor 40 and the rotation speed (rotation amount) of the bit movement motor 50 change according to a change in the load applied in the axial direction of the driver bit 2 and a change in the load applied in the rotation direction of the driver bit 2.

The fastening tool 1 determines whether to drill the hole in the fastening target in which a hole is not easily drilled such as a steel sheet, and controls the bit movement motor 50 according to the fastening target. Therefore, the fastening tool 1 includes a load detector 112 that detects the change in the load applied in the axial direction of the driver bit 2, the change in the load applied in the rotation direction of the driver bit 2, or the change in the load applied in the axial direction of the driver bit 2 and the change in the load applied in the rotation direction of the driver bit 2 in the operation of moving the screw 200 engaged with the driver bit 2 forward to drill the hole in the fastening target.

In an operation of rotating the driver bit 2 and moving the driver bit 2 in the axial direction to fasten the screw 200 to the fastening target, both the load applied in the axial direction of the driver bit 2 and the load applied in the rotation direction of the driver bit 2 increase, and the rotation speed of the bit movement motor 50 and the rotation speed of the bit rotation motor 40 decrease.

However, in the operation of moving the screw 200 engaged with the driver bit 2 forward to drill the hole in the fastening target, when the hole is drilled in the fastening target in which a hole is not easily drilled such as a steel sheet, the reduction amount of the rotation speed of the bit movement motor 50 increases by an increase in the load applied in the axial direction of the driver bit 2. On the other hand, when the hole is drilled in the fastening target in which a hole is not easily drilled such as a steel sheet, since the screw 200 idles, the reduction amount of the rotation speed of the bit rotation motor 40 decreases as the load applied in the rotation direction of the driver bit 2 decreases.

Therefore, the load detector 112 detects a predetermined change in the load applied in the axial direction of the driver bit 2 and/or the load applied in the rotation direction of the driver bit 2 based on a change in the rotation speed of the bit movement motor 50 and/or the rotation speed of the bit rotation motor 40.

The load detector 112 detects, based on a predetermined increase in the reduction amount of the rotation speed of the bit movement motor 50 or a predetermined decrease in the reduction amount of the rotation speed of the bit rotation motor 40, a predetermined load corresponding to that the screw 200 is moved forward to drill the hole in the fastening target in which a hole is not easily drilled such as a steel sheet.

When it is determined that the screw 200 is moved forward to drill the hole in the fastening target in which a hole is not easily drilled such as a steel sheet based on the predetermined load detected by the load detector 112, the controller 100 switches a first load control for driving the bit movement motor 50 with a first output corresponding to fastening of the screw 200 to the normal fastening target such as wood or gypsum to a second load control for driving the bit movement motor 50 with a second output corresponding to the increase in the load when the screw 200 is moved forward to drill the hole in the fastening target in which a hole is not easily drilled such as a steel sheet. In the second load control, the controller 100 limits a current flowing to the bit movement motor 50, and decreases the output, here, the rotation speed of the bit movement motor 50.

When the rotation of the bit movement motor 50 is maintained at a rotation speed corresponding to the rotation speed of the bit rotation motor 40 in a state where the movement amount (forward movement amount) of the driver bit 2 is decreased by the increase in the load of moving the screw 200 forward to press the screw 200 against the fastening target, such as a steel sheet, to drill the hole, an actual movement amount (forward movement amount) of the driver bit 2 becomes smaller than the movement amount (forward movement amount) in the axial direction of the screw 200 fastened by the rotation of the bit rotation motor 40, that is, a target movement amount (forward movement amount) of the driver bit 2 by the rotation of the bit movement motor 50. Accordingly, the fastening tool 1 floats by the reaction force of the force by which the driver bit 2 presses the fastening target via the screw 200.

Therefore, in the second load control, the rotation speed of the bit movement motor 50 is reduced to such an extent that the rotation speed follows the movement amount (forward movement amount) of the driver bit 2 which is decreased with the increase in the load of pressing the screw 200 against the fastening target to drill a hole. Accordingly, the target movement amount (forward movement amount) of the driver bit 2 by the rotation of the bit movement motor 50 and the actual movement amount (forward movement amount) of the driver bit 2 are substantially equal to each other, generation of the reaction force of the force by which the driver bit 2 presses the fastening target via the screw 200 is prevented, and the floating of the fastening tool 1 is prevented.

The controller 100 switches the first load control to the second load control based on, for example, the change in the rotation speed of the bit movement motor 50. Therefore, the controller 100 sets a high-load deceleration threshold value corresponding to the reduction amount of the rotation speed of the bit movement motor 50 with the increase in the load applied in the axial direction of the driver bit 2 as a threshold value for determining whether to perform the operation of moving the screw 200 forward to drill the hole in the fastening target in which a hole is not easily drilled such as a steel sheet.

The high-load deceleration threshold value may be set by a magnitude of the rotation speed of the bit movement motor 50. In this case, during execution of the first load control, when the rotation speed of the bit movement motor 50 becomes less than the high-load deceleration threshold value, the controller 100 switches the first load control to the second load control described above.

In addition, the high-load deceleration threshold value may be set by a difference between the target movement amount of the driver bit 2 obtained from the rotation speed of the bit movement motor 50 and the actual movement amount of the driver bit 2. In this case, during the execution of the first load control, when the difference between the target movement amount of the driver bit 2 and the actual movement amount of the driver bit 2 becomes equal to or greater than the high-load deceleration threshold value, the controller 100 switches the first load control to the second load control described above. The target movement amount of the driver bit 2 may be acquired from the movement amount in the axial direction of the screw 200 fastened by the rotation of the bit rotation motor 40.

Further, the high-load deceleration threshold value may be set by an integrated value of the difference between the target movement amount of the driver bit 2 and the actual movement amount of the driver bit 2. In this case, during the execution of the first load control, the difference between the target movement amount of the driver bit 2 and the actual movement amount of the driver bit 2 is acquired at a predetermined sampling interval. When the difference is equal to or greater than the predetermined threshold value, the difference is integrated. When the integrated value of the difference equal to or greater than the predetermined threshold value is equal to or greater than the high-load deceleration threshold value, the controller 100 switches the first load control to the second load control described above.

During execution of the second load control described above, the controller 100 executes hole drilling control for drilling the hole in the fastening target in which a hole is not easily drilled such as a steel sheet.

When it is determined that the rotation speed of the bit movement motor 50 does not increase and is less than a defined value in the hole drilling control during the execution of the second load control, the controller 100 increases the current flowing to the bit movement motor 50 from a current value limited by the second load control. That is, when it is continuously detected a predetermined number of times at a predetermined sampling interval that the rotation speed of the bit movement motor 50 does not increase and the actual movement amount of the driver bit 2 is less than a defined value, for example, the actual movement amount of the driver bit 2 is 0, the controller 100 increases the output, here, the rotation speed of the bit movement motor 50 and gradually increases the movement amount (forward movement amount) along the axial direction of the driver bit 2.

When the screw 200 drills the hole in the fastening target in which a hole is not easily drilled such as a steel sheet, a resistance when the screw 200 moves forward decreases, the load applied to the bit movement motor 50 decreases, and the rotation speed of the bit movement motor 50 increases. In the hole drilling control during the execution of the second load control, when it is determined that the rotation speed of the bit movement motor 50 is equal to or larger than the defined value, the controller 100 switches from the second load control to the first load control and releases the limitation of the current flowing to the bit movement motor 50.

The fastening tool 1 includes a setting portion 110 in which the rotation amount or the like of the bit movement motor 50, which defines the forward movement amount of the driver bit 2, is set. FIG. 6 is a perspective view showing an example of a setting portion. Next, the setting portion 110 will be described with reference to each drawing.

The setting portion 110 is an example of a setting unit and may select any setting value from a plurality of setting values or any setting value continuously.

In this example, in the setting portion 110, the setting value is selected by an operation portion 110a configured by a button. In the operation portion 110a, the setting value may be selected by a rotary dial. The setting portion 110 may display the selected setting value by a method of indicating a current value with a label, a mark, or the like, a method of indicating the current value on a display portion 110b such as an LED, or the like so that an operator may easily grasp a current setting value. Contents displayed on the display portion 110b include, in addition to a setting value of a screw depth defined by the forward movement amount of the driver bit 2, an ON/OFF state of a power supply, an operation mode selected from various selectable operation modes, presence or absence of the screw, a remaining amount of the screw, and presence or absence of an abnormality.

The setting portions 110 are provided on both left and right sides of a surface facing the handle 11 in the substrate storage portion 111 provided on the back side of the screw storage portion 6.

Accordingly, when the fastening tool 1 is viewed from the rear, the setting portions 110 may be visually recognized from both the left and right sides of the handle 11.

Operation Example of Fastening Tool of the Present Embodiment

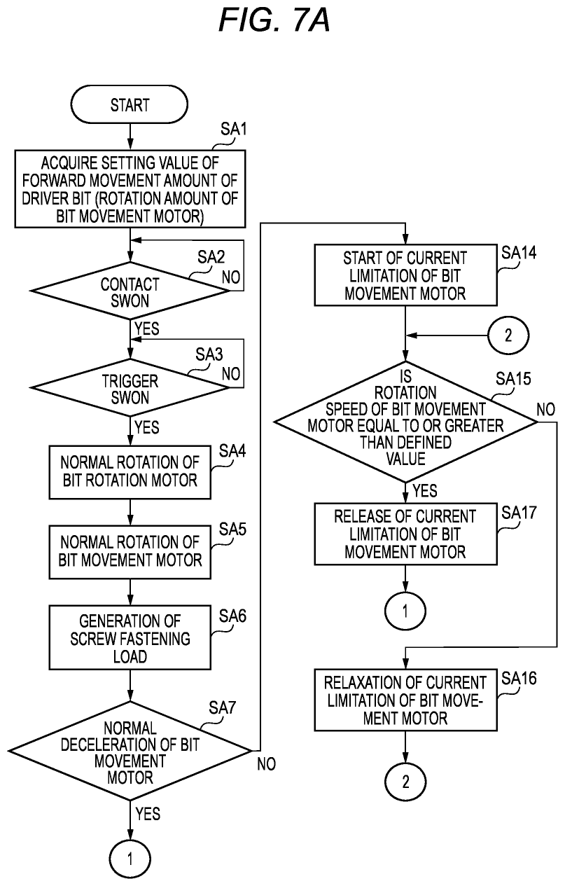

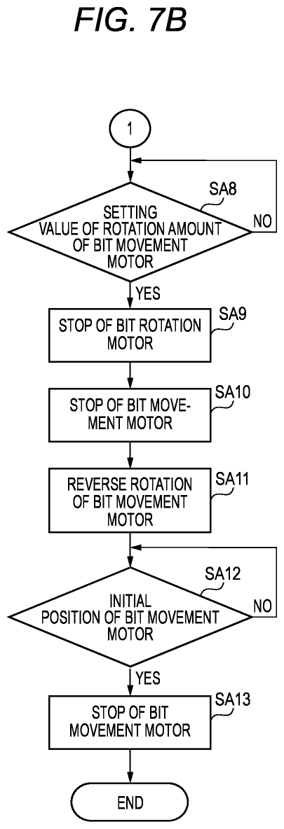

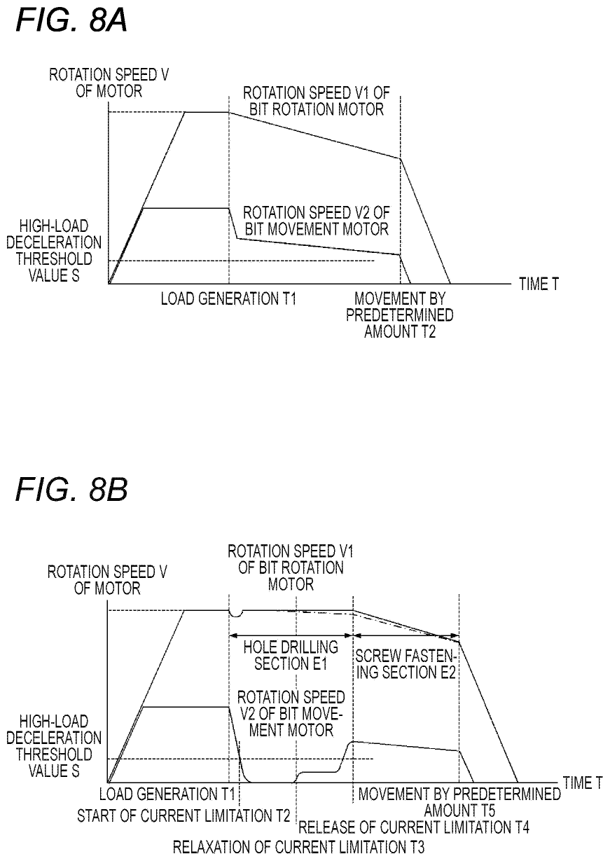

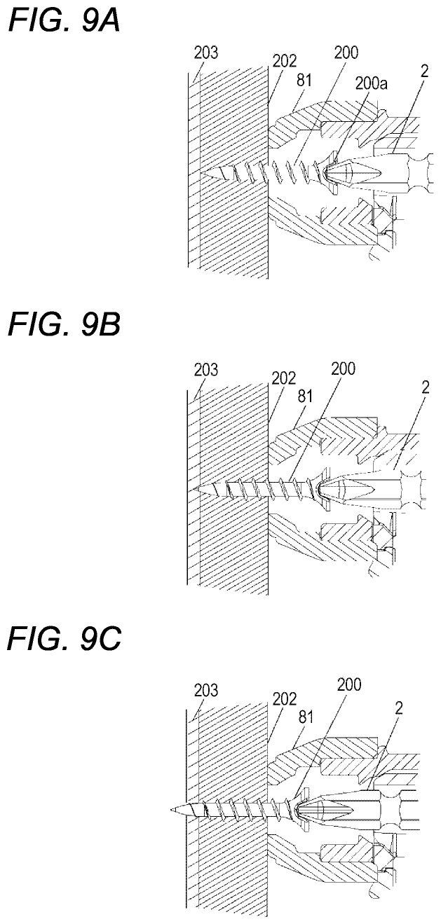

FIGS. 7A and 7B are flowcharts showing an example of an operation of the fastening tool of the present embodiment, FIGS. 8A and 8B are graphs showing a relation between the rotation speeds of the bit rotation motor and the bit movement motor, and FIGS. 9A, 9B, and 9C are cross-sectional views showing a fastened state of the screw. Next, an example of a fastening operation of the fastening tool of the present embodiment will be described with reference to each drawing.

In a standby state of the fastening tool 1, as shown in FIG. 1A, a tip of the driver bit 2 is positioned at a standby position P1 behind the injection passage 80, and the screw 200 may be supplied to the injection passage 80.

In step SA1 of FIG. 7A, the controller 100 sets the rotation amount of the bit movement motor 50, which defines the forward movement amount of the driver bit 2, based on the setting value selected by the setting portion 110. When the contact member 81 is pressed against a fastening target 202, the contact switch portion 84 is pressed by the contact arm 82 and is ON in step SA2, the trigger 9 is operated, and the trigger switch portion 90 is ON in step SA3, the controller 100 drives the bit rotation motor 40 of the first driving portion 4 in step SA4 and drives the bit movement motor 50 of the second driving portion 5 to execute the first load control in step SA5.

When the bit movement motor 50 is driven to rotate in a forward direction, which is one direction, the pulley 52 rotates in the forward direction so that the wire 54 is wound around the pulley 52. When the wire 54 is wound around the pulley 52, the second moving member 32c connected to the wire 54 is guided by the rotation guide member 31 and moves in the front direction along the axial direction. When the second moving member 32c moves in the front direction, the first moving member 32a is pressed to the second moving member 32c via the bearing 32b and moves in the front direction along the axial direction while compressing the biasing member 33 together with the second moving member 32c.

When the first moving member 32a moves in the front direction, the holding member 30 connected to the first moving member 32a by the connection member 30b moves in the front direction along the axial direction of the driver bit 2 while the connection member 30b is guided by the groove portion 31a of the rotation guide member 31.

Accordingly, the driver bit 2 held by the holding member 30 moves in the front direction indicated by the arrow A1, engages with the screw 200 supplied to the injection port 81a of the nose portion 8 to move the screw 200 in the front direction and press the screw 200 against the fastening target 202.

When the bit rotation motor 40 is driven to rotate in the forward direction, which is one direction, the rotation guide member 31 rotates in the forward direction. When the rotation guide member 31 rotates in the forward direction, the connection member 30b connected to the holding member 30 is pressed to the groove portion 31a of the rotation guide member 31 so that the holding member 30 rotates together with the rotation guide member 31.

Accordingly, the driver bit 2 held by the holding member 30 rotates the screw 200 in the forward direction (clockwise) to fasten the screw 200 to the fastening target 202. The controller 100 moves the driver bit 2 in the front direction by the second driving portion 5 based on the load applied to the bit rotation motor 40, the number of rotations of the bit rotation motor 40, the load applied to the bit movement motor 50, and the number of rotations of the bit movement motor 50 in conjunction with the operation of rotating the driver bit 2 by the first driving portion 4 to fasten the screw 200 to the fastening target 202, thereby causing the driver bit 2 to follow the screw 200 fastened to the fastening target 202.

FIG. 8A shows a relation between the rotation speeds of the bit rotation motor 40 and the bit movement motor 50 in a case where the screw 200 is fastened to the normal fastening target 202 such as wood or gypsum, and FIG. 8B shows the relation between the rotation speeds of the bit rotation motor 40 and the bit movement motor 50 in a case where the fastening target 202 such as gypsum is stacked on a base of a steel sheet 203 and the screw 200 is fastened to the steel sheet 203.

When the operation of rotating the driver bit 2 to fasten the screw 200 to the fastening target 202 is started, a load applied to the driver bit 2 via the screw 200 is generated in step SA6. When the load applied to the driver bit 2 is generated, a rotation speed V1 of the bit rotation motor 40 and a rotation speed V2 of the bit movement motor 50 both decrease. However, the load applied to the driver bit 2 via the screw 200 is different between the case where the screw 200 is fastened to the normal fastening target 202 such as wood or gypsum and the case where the fastening target 202 such as gypsum is stacked on the base of the steel sheet 203 and the screw 200 is fastened to the steel sheet 203.

In particular, in the case of the steel sheet 203 or the like in which a hole is not easily drilled, as shown in FIG. 9A, when the tip end of the screw 200 reaches the steel sheet 203, a load when the screw 200 is pressed against the steel sheet 203 is larger than that of wood or gypsum, and a load when the driver bit 2 is moved (moved forward) in the axial direction is larger. Accordingly, a reduction amount of the rotation speed V2 of the bit movement motor 50 is larger in the case where the screw 200 is fastened to the steel sheet 203 shown in FIG. 8B than in the case where the screw 200 is fastened to the normal fastening target 202 such as wood or gypsum shown in FIG. 8A.

Therefore, in step SA7, the controller 100 determines whether the reduction amount of the rotation speed of the bit movement motor 50 is within a normal deceleration range by comparing the rotation speed V2 of the bit movement motor 50 and a high-load deceleration threshold value S.

When it is determined that the rotation speed V2 of the bit movement motor 50 does not fall below the high-load deceleration threshold value S and the reduction amount of the rotation speed of the bit movement motor 50 is within the normal deceleration range as shown in FIG. 8A in a process in which the rotation speed V2 of the bit movement motor 50 decreases after a load generation timing T1, the controller 100 determines that the screw 200 is fastened to the normal fastening target 202 such as wood or gypsum and continues the first load control.

When it is determined in step SA8 that the rotation amount of the bit movement motor 50 becomes the setting value selected by the setting portion 110 and the tip of the driver bit 2 reaches a set operation end position, the controller 100 stops the driving of the bit rotation motor 40 in step SA9 at a timing T2 when the driver bit 2 moves by a defined amount shown in FIG. 8A, stops the rotation in the forward direction of the bit movement motor 50 in step SA10, and then reversely rotates the bit movement motor 50 in step SA11.

When the bit movement motor 50 rotates in the reverse direction, which is the other direction, the pulley 52 rotates in the reverse direction so that the wire 54 is pulled out from the pulley 52. When the wire 54 is pulled out from the pulley 52, the biasing member 33 compressed by the movement in the front direction of the second moving member 32c extends and presses the second moving member 32c in the rear direction.

When being pressed in the rear direction by the biasing member 33, the second moving member 32c is guided by the rotation guide member 31 and moves in the rear direction along the axial direction. When the second moving member 32c moves in the rear direction, the first moving member 32a is pulled by the second moving member 32c via the bearing 32b and moves in the rear direction along the axial direction together with the second moving member 32c.

When the first moving member 32a moves in the rear direction, the holding member 30 connected to the first moving member 32a by the connection member 30b moves in the rear direction along the axial direction of the driver bit 2 while the connection member 30b is guided by the groove portion 31a of the rotation guide member 31.

When the bit movement motor 50 reversely rotates to an initial position at which the wire 54 is pulled out from the pulley 52 by a predetermined amount, and the holding member 30 and the moving member 32 move in the rear direction to a position at which the tip of the driver bit 2 returns to the standby position P1 in step SA12, the controller 100 stops the reverse rotation of the bit movement motor 50 in step SA13.

When the trigger switch portion 90 is OFF, the controller 100 rotates the screw feed motor 70 in one direction to lower the engagement portion 73. When the engagement portion 73 is lowered to a position at which the engagement portion 73 engages with a next screw 200, the controller 100 reversely rotates the screw feed motor 70 to raise the engagement portion 73 and supply the next screw 200 to the injection passage 80.

When it is determined that the rotation speed V2 of the bit movement motor 50 falls below the high-load deceleration threshold value S and the reduction amount of the rotation speed of the bit movement motor 50 is equal to or greater than the normal deceleration range as shown in FIG. 8B in the comparison between the rotation speed V2 of the bit movement motor 50 and the high-load deceleration threshold value S in step SA7, the controller 100 determines that the screw 200 is pressed against the steel sheet 203 and switches the first load control to the second load control in step SA14. In the second load control, the controller 100 limits the current flowing to the bit movement motor 50, and decreases the output, here, the rotation speed of the bit movement motor 50. Accordingly, the timing T2 at which the current limitation is started is when the rotation speed V2 of the bit movement motor 50 falls below the high-load deceleration threshold value S.

The controller 100 executes the hole drilling control for drilling a hole in the steel sheet 203 during the execution of the second load control in which the rotation of the bit rotation motor 40 is continued while limiting the rotation speed of the bit movement motor 50.

The controller 100 detects the rotation speed of the bit movement motor 50 at a predetermined sampling interval in a hole drilling section E1 in which the hole drilling control is performed during the execution of the second load control, and determines whether the rotation speed of the bit movement motor 50 is equal to or greater than a defined value for releasing the second load control at a timing T3 at which presence or absence of relaxation of the current limitation shown in FIG. 8B is determined.

When it is determined in step SA15 that the rotation speed of the bit movement motor 50 does not reach a defined value for releasing the second load control, the controller 100 increases the current flowing to the bit movement motor 50 from the current value limited by the second load control in step SA16. By increasing the current flowing to the bit movement motor 50, the output, here, the rotation speed of the bit movement motor 50 is increased, and the movement amount (forward movement amount) along the axial direction of the driver bit 2 is gradually increased.

Accordingly, the force of pressing the screw 200 against the fastening target through the driver bit 2 is gradually increased to prevent the increase in the reaction force of the force by which the driver bit 2 presses the fastening target via the screw 200, and the hole is easily drilled in the steel sheet 203 as shown in FIG. 9B.

When determining in step SA15 that the rotation speed of the bit movement motor 50 is equal to or greater than the defined value for releasing the second load control, the controller 100 switches from the second load control to the first load control in step SA17, and releases the limitation on the current flowing to the bit movement motor 50 at a timing T4 at which the current limitation is released shown in FIG. 8B.

That is, as shown in FIG. 9C, when the screw 200 drills a hole in the steel sheet 203, the screw 200 may move (move forward) in the axial direction, and a load when the driver bit 2 moves (moves forward) in the axial direction decreases. Accordingly, the movement amount along the axial direction of the driver bit 2 may follow the movement amount along the axial direction of the screw 200 when the screw 200 is fastened to the steel sheet 203 by rotation, and the rotation speed of the bit movement motor 50 increases. Therefore, by releasing the limitation on the current flowing to the bit movement motor 50, in a screw fastening section E2, the driver bit 2 may follow the screw 200 fastened to the fastening target 202 and the steel sheet 203, and the screw 200 may be fastened to the fastening target 202 and the steel sheet 203.

The controller 100 may detect the rotation speed of the bit movement motor 40 at the predetermined sampling interval in the hole drilling section E1 in which the hole drilling control is performed during the execution of the second load control, and may determine whether a decrease range of the reduction amount of the rotation speed of the bit rotation motor 40 is equal to or greater than the defined value for releasing the second load control of the bit movement motor 50 at the timing T3 at which the presence or absence of the relaxation of the current limitation shown in FIG. 8B is determined. In the hole drilling section E1 in which the hole drilling control is performed during the execution of the second load control, as indicated by a dashed line in FIG. 8B, after the screw 200 idles and the reduction amount of the rotation speed of the bit rotation motor 40 decreases, the reduction amount of the rotation speed of the bit rotation motor 40 may increase again due to an increase in the load caused by a start of drilling a hole in the steel sheet 203. Therefore, the controller 100 increases the current flowing to the bit movement motor 50 from the current value limited by the second load control when determining that the decrease range of the reduction amount of the rotation speed of the bit rotation motor 40 increases and is equal to or greater than the defined value for releasing the second load control of the bit movement motor 50.

In the operation of fastening the screw 200 to the steel sheet 203, a subsequent operation is the same as that of the normal fastening target. When it is determined in step SA8 that the rotation amount of the bit movement motor 50 becomes the setting value selected by the setting portion 110 and the tip of the driver bit 2 reaches the set operation end position, the controller 100 stops the driving of the bit rotation motor 40 in step SA9 at a timing T5 when the driver bit 2 moves by a defined amount shown in FIG. 8B, stops the rotation in the forward direction of the bit movement motor 50 in step SA10, and then reversely rotates the bit movement motor 50 in step SA11.

When the holding member 30 and the moving member 32 move in the rear direction to the position where the tip of the driver bit 2 returns to the standby position P1 in step SA12, the controller 100 stops the reverse rotation of the bit movement motor 50 in step SA13.

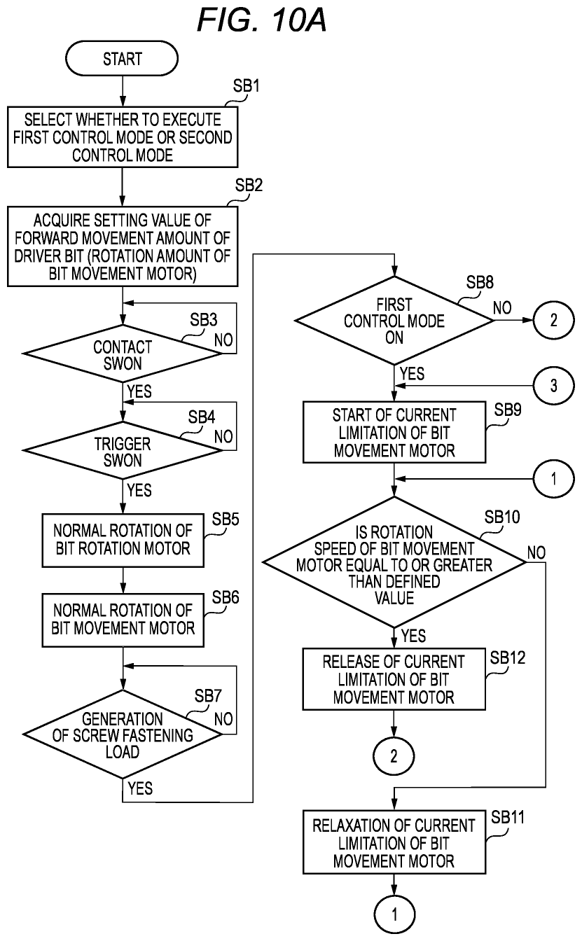

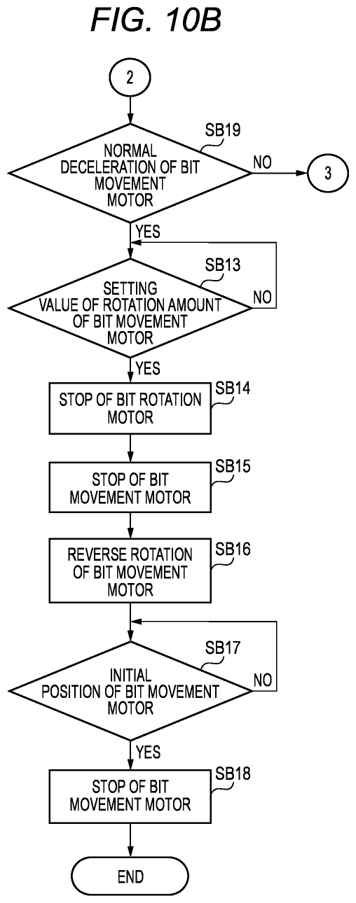

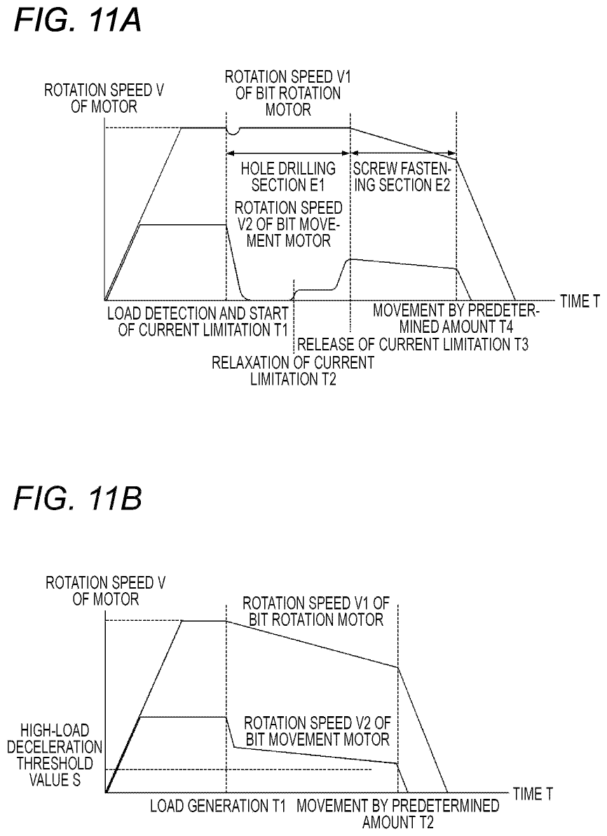

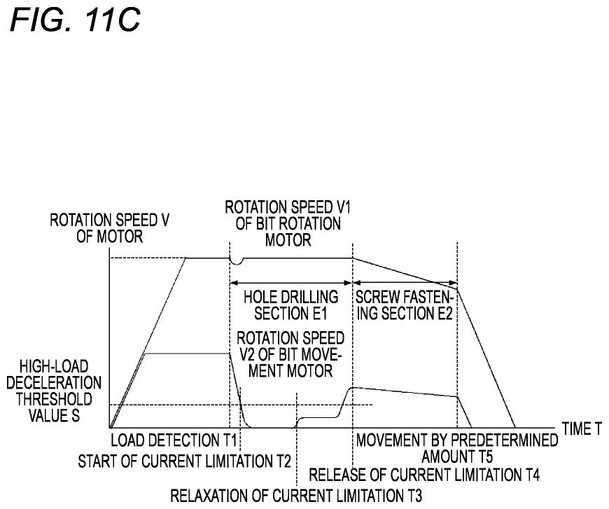

FIGS. 10A and 10B are flowcharts showing another example of the operation of the fastening tool of the present embodiment, and FIGS. 11A, 11B, and 11C are graphs showing the relation between the rotation speeds of the bit rotation motor and the bit movement motor. Next, another example of the fastening operation of the fastening tool of the present embodiment will be described with reference to each drawing. In another example of the fastening operation, in the fastening tool 1 that switches the first load control and the second load control described above, a first control mode in which the first load control is executed regardless of a magnitude of the load applied in the axial direction of the driver bit 2 and a second control mode in which the second load control is executed according to the magnitude of the load applied in the axial direction of the driver bit 2 may be switched by the setting portion 110. Therefore, the setting portion 110 is an example of a mode switch portion capable of switching the control mode between the first control mode and the second control mode. The second control mode is also referred to as a steel sheet mode.

In step SB1 of FIG. 10A, the setting portion 110 of the fastening tool 1 selects whether to execute the first control mode or the second control mode.

In step SB2, the controller 100 sets the rotation amount of the bit movement motor 50, which defines the forward movement amount of the driver bit 2, based on the setting value selected by the setting portion 110. When the contact switch portion 84 is in the ON state in step SB3 and the trigger switch portion 90 is in the ON state in step SB4, the controller 100 drives the bit rotation motor 40 of the first driving portion 4 in step SB5 and drives the bit movement motor 50 of the second driving portion 5 in step SB6.

When the bit movement motor 50 is driven to rotate in the forward direction, which is one direction, the driver bit 2 held by the holding member 30 of the bit holding portion 3 moves in the front direction indicated by the arrow A1, engages with the screw 200 supplied to the injection port 81a of the nose portion 8 to move the screw 200 in the front direction and press the screw 200 against the fastening target.

When the bit rotation motor 40 is driven to rotate in the forward direction, which is one direction, the driver bit 2 held by the holding member 30 of the bit holding portion 3 rotates the screw 200 in the forward direction (clockwise) and fastens the screw 200 to the fastening target. The controller 100 moves the driver bit 2 in the front direction by the second driving portion 5 based on the load applied to the bit rotation motor 40, the number of rotations of the bit rotation motor 40, the load applied to the bit movement motor 50, and the number of rotations of the bit movement motor 50 in conjunction with the operation of rotating the driver bit 2 by the first driving portion 4 to fasten the screw 200 to the fastening target, thereby causing the driver bit 2 to follow the screw 200 fastened to the fastening target.

When the operation of rotating the driver bit 2 to fasten the screw 200 to the fastening target 202 is started, the load applied to the driver bit 2 via the screw 200 is generated. When detecting the load caused by fastening the screw 200 in step SB7, the controller 100 determines whether the execution of the first control mode is selected in step SB8.

When determining that the execution of the first control mode is selected, as shown in FIG. 11A, after determining that the movement speed of the bit holding portion 3 decreases when the screw 200 engaged with the driver bit 2 is fastened to the fastening target 202 by detecting the load caused by fastening the screw 200 in step SB7 described above, the controller 100 switches the first load control to the second load control in step SB9 without detecting the load applied in the axial direction of the driver bit 2 and determining the magnitude thereof. In the second load control, the controller 100 limits the current flowing to the bit movement motor 50, and decreases the output, here, the rotation speed of the bit movement motor 50.

The controller 100 executes the hole drilling control for drilling a hole in the steel sheet 203 during the execution of the second load control in which the rotation of the bit rotation motor 40 is continued while limiting the rotation speed of the bit movement motor 50.

The controller 100 detects the rotation speed of the bit movement motor 50 at the predetermined sampling interval in the hole drilling section E1 in which the hole drilling control is performed during the execution of the second load control, and determines whether the rotation speed of the bit movement motor 50 is equal to or greater than the defined value for releasing the second load control at the timing T2 at which the presence or absence of the relaxation of the current limitation is determined.

When it is determined in step SB10 that the rotation speed of the bit movement motor 50 does not reach the defined value for releasing the second load control, the controller 100 increases the current flowing to the bit movement motor 50 from the current value limited by the second load control in step SB11. By increasing the current flowing to the bit movement motor 50, the output, here, the rotation speed of the bit movement motor 50 is increased, and the movement amount (forward movement amount) along the axial direction of the driver bit 2 is gradually increased.

Accordingly, the force of pressing the screw 200 against the fastening target through the driver bit 2 is gradually increased to prevent the increase in the reaction force of the force by which the driver bit 2 presses the fastening target via the screw 200, and the hole is easily drilled in the steel sheet 203.

When determining in step SB10 that the rotation speed of the bit movement motor 50 is equal to or greater than the defined value for releasing the second load control, the controller 100 switches from the second load control to the first load control in step SB12, and releases the limitation on the current flowing to the bit movement motor 50 at the timing T3 at which the current limitation is released.

That is, when the screw 200 drills a hole in the steel sheet 203, the screw 200 may move (move forward) in the axial direction, and the load when the driver bit 2 moves (moves forward) in the axial direction decreases. Accordingly, the movement amount along the axial direction of the driver bit 2 may follow the movement amount along the axial direction of the screw 200 when the screw 200 is fastened to the steel sheet 203 by rotation, and the rotation speed of the bit movement motor 50 increases. Therefore, by releasing the limitation on the current flowing to the bit movement motor 50, in the screw fastening section E2, the driver bit 2 may follow the screw 200 fastened to the fastening target 202 and the steel sheet 203, and the screw 200 may be fastened to the fastening target 202 and the steel sheet 203.

When it is determined in step SB13 that the rotation amount of the bit movement motor 50 becomes the setting value selected by the setting portion 110 and the tip of the driver bit 2 reaches the set operation end position, the controller 100 stops the driving of the bit rotation motor 40 in step SB14 at the timing T4 when the driver bit 2 moves by the defined amount, stops the rotation in the forward direction of the bit movement motor 50 in step SB15, and then reversely rotates the bit movement motor 50 in step SB16.

When the holding member 30 and the moving member 32 move in the rear direction to the position where the tip of the driver bit 2 returns to the standby position P1 in step SB17, the controller 100 stops the reverse rotation of the bit movement motor 50 in step SB18.

When determining in step SB8 that the execution of the first control mode is not selected, the controller 100 determines whether the reduction amount of the rotation speed of the bit movement motor 50 is within the normal deceleration range by comparing the rotation speed V2 of the bit movement motor 50 and the high-load deceleration threshold value S in step SB19. When it is determined that the rotation speed V2 of the bit movement motor 50 does not fall below the high-load deceleration threshold value S after a load detection timing T1 by fastening the screw 200 as shown in FIG. 11B, the movement speed of the bit holding portion 3 exceeds a predetermined speed when the screw 200 engaged with the driver bit 2 is fastened to the fastening target 202, and the reduction amount of the rotation speed of the bit movement motor 50 is within the normal deceleration range, the controller 100 determines that the screw 200 is fastened to the normal fastening target 202 such as wood or gypsum and continues the first load control described above.

When it is determined that the execution of the first control mode is not selected in step SB8, in step SB19, when determining that the rotation speed V2 of the bit movement motor 50 falls below the high-load deceleration threshold value S as shown in FIG. 11C, the movement speed of the bit holding portion 3 is equal to or lower than the predetermined speed when the screw 200 engaged with the driver bit 2 is fastened to the fastening target 202, and the reduction amount of the rotation speed of the bit movement motor 50 is equal to or greater than the normal deceleration range, the controller 100 switches the first load control to the second load control to execute the second load control described above in step SB9. In the second load control, the controller 100 limits the current flowing to the bit movement motor 50, and decreases the output, here, the rotation speed of the bit movement motor 50.

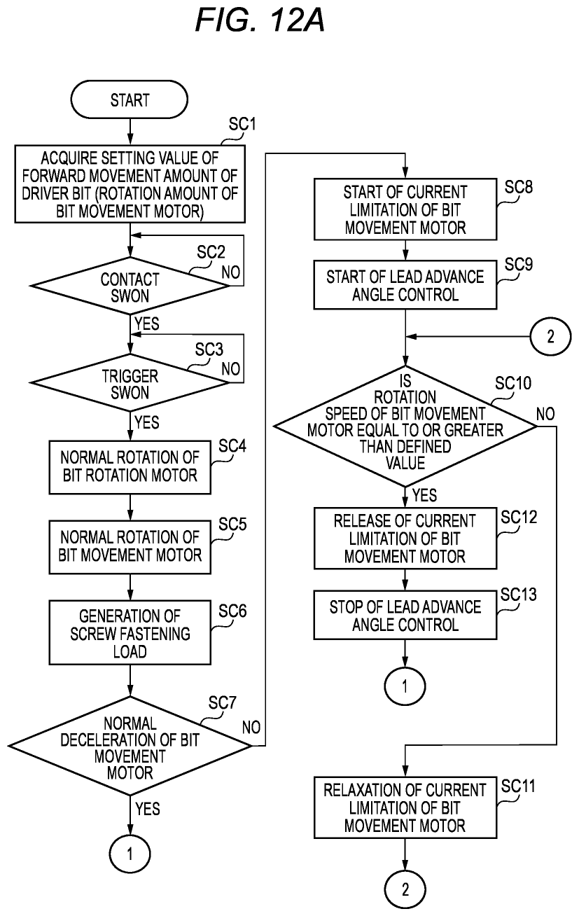

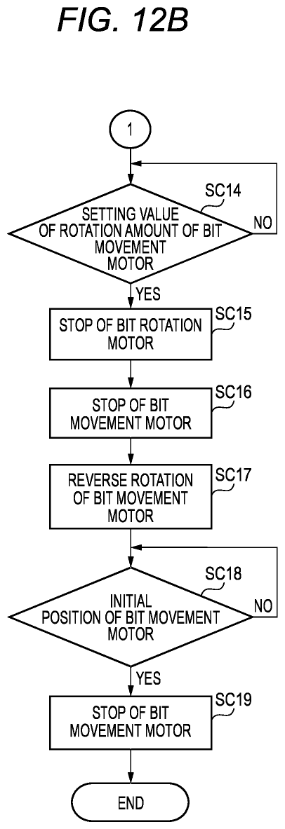

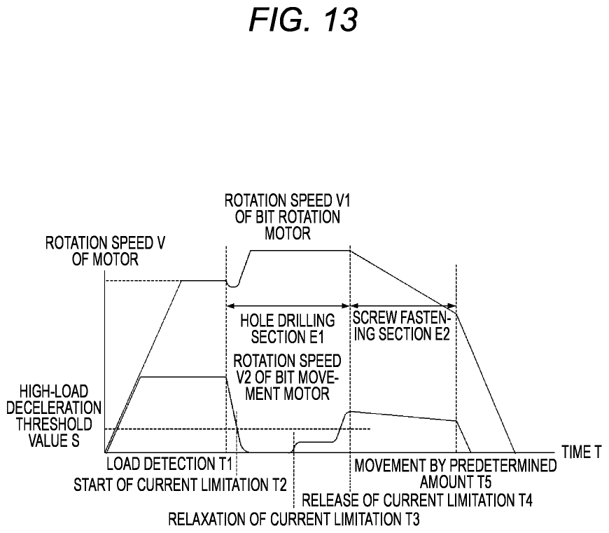

FIGS. 12A and 12B are flowcharts showing another example of the operation of the fastening tool of the present embodiment, and FIG. 13 is a graph showing the relation between the rotation speeds of the bit rotation motor and the bit movement motor. Next, still another example of the fastening operation of the fastening tool of the present embodiment will be described with reference to each drawing. In still another example of the fastening operation, in the fastening tool 1 that switches between the first load control and the second load control described above, the lead advance angle control is executed at a predetermined timing with respect to the bit rotation motor 40, which rotates the driver bit 2, to increase the rotation speed.

Specifically, the lead advance angle control is realized by using a motor to which a sensor for detecting switching in a rotor magnetic force direction is attached at a position of a normal 30-degree advance angle and delaying an energization switching from a time point when a sensor signal earlier by one commutation is detected with respect to a normal energization state.

In step SC1, the controller 100 sets the rotation amount of the bit movement motor 50, which defines the forward movement amount of the driver bit 2, based on the setting value selected by the setting portion 110. When the contact switch portion 84 is in the ON state in step SC2 and the trigger switch portion 90 is in the ON state in step SC3, the controller 100 drives the bit rotation motor 40 of the first driving portion 4 in step SC4 and drives the bit movement motor 50 of the second driving portion 5 in step SC5.

The controller 100 does not execute the lead advance angle control until the number of rotations increases to a defined value after the start of driving the bit rotation motor 40. This is because when the lead advance angle control is executed, a torque becomes weak, and therefore, when the lead advance angle control is executed immediately after the start of driving, it takes time to increase the rotation speed.

When the bit movement motor 50 is driven to rotate in the forward direction, which is one direction, the driver bit 2 held by the holding member 30 of the bit holding portion 3 moves in the front direction indicated by the arrow A1, engages with the screw 200 supplied to the injection port 81a of the nose portion 8 to move the screw 200 in the front direction and press the screw 200 against the fastening target.

When the bit rotation motor 40 is driven to rotate in the forward direction, which is one direction, the driver bit 2 held by the holding member 30 of the bit holding portion 3 rotates the screw 200 in the forward direction (clockwise) and fastens the screw 200 to the fastening target. The controller 100 moves the driver bit 2 in the front direction by the second driving portion 5 based on the load applied to the bit rotation motor 40, the number of rotations of the bit rotation motor 40, the load applied to the bit movement motor 50, and the number of rotations of the bit movement motor 50 in conjunction with the operation of rotating the driver bit 2 by the first driving portion 4 to fasten the screw 200 to the fastening target, thereby causing the driver bit 2 to follow the screw 200 fastened to the fastening target.

When the operation of rotating the driver bit 2 to fasten the screw 200 to the fastening target 202 is started, the load applied to the driver bit 2 via the screw 200 is generated in step SC6. When the load applied to the driver bit 2 is generated, in step SC7, the controller 100 determines whether the reduction amount of the rotation speed of the bit movement motor 50 is within the normal deceleration range by comparing the rotation speed V2 of the bit movement motor 50 and the high-load deceleration threshold value S.

When it is determined that the rotation speed V2 of the bit movement motor 50 falls below the high-load deceleration threshold value S and the reduction amount of the rotation speed of the bit movement motor 50 is equal to or greater than the normal deceleration range as shown in FIG. 13 in the comparison between the rotation speed V2 of the bit movement motor 50 and the high-load deceleration threshold value S in step SC7, the controller 100 determines that the screw 200 is pressed against the steel sheet 203 and switches the first load control to the second load control in step SC8. In the second load control, the controller 100 limits the current flowing to the bit movement motor 50, and decreases the output, here, the rotation speed of the bit movement motor 50.

When switching the first load control to the second load control, the controller 100 executes the lead advance angle control in step SC9. In the case of the fastening target in which a hole is not easily drilled such as a steel sheet, the screw 200 is in the idling state until the tip of the screw 200 drills a hole in the steel sheet, and thus the load applied in the rotation direction of the driver bit 2 is reduced. When the lead advance angle control is executed on the bit rotation motor 40 in a state where the load applied to the bit rotation motor 40 is light, the rotation speed of the bit rotation motor 40 further increases.

As a result, when the tip of the screw 200 reaches the steel sheet, the rotation speed of the bit rotation motor 40 is increased, whereby the hole drilling in the steel sheet due to the idle rotation of the screw 200 is promoted.

The controller 100 executes the hole drilling control for drilling a hole in the steel sheet 203 during the execution of the second load control in which the rotation of the bit rotation motor 40 is continued while limiting the rotation speed of the bit movement motor 50.

The controller 100 detects the rotation speed of the bit movement motor 50 at the predetermined sampling interval in the hole drilling section E1 in which the hole drilling control is performed during the execution of the second load control, and determines whether the rotation speed of the bit movement motor 50 is equal to or greater than the defined value for releasing the second load control at the timing T3 at which the presence or absence of the relaxation of the current limitation shown in FIG. 13 is determined.

When it is determined in step SC10 that the rotation speed of the bit movement motor 50 does not reach the defined value for releasing the second load control, the controller 100 increases the current flowing to the bit movement motor 50 from the current value limited by the second load control in step SC11. By increasing the current flowing to the bit movement motor 50, the output, here, the rotation speed of the bit movement motor 50 is increased, and the movement amount (forward movement amount) along the axial direction of the driver bit 2 is gradually increased.

Accordingly, the force of pressing the screw 200 against the fastening target through the driver bit 2 is gradually increased to prevent the increase in the reaction force of the force by which the driver bit 2 presses the fastening target via the screw 200, and the hole is easily drilled in the steel sheet 203.

When determining in step SC10 that the rotation speed of the bit movement motor 50 is equal to or greater than the defined value for releasing the second load control, the controller 100 switches from the second load control to the first load control in step SC12, and releases the limitation on the current flowing to the bit movement motor 50 at the timing T4 at which the current limitation is released shown in FIG. 11. When switching the second load control to the first load control, the controller 100 stops the lead advance angle control in step SC13.

That is, when the screw 200 drills a hole in the steel sheet 203, the screw 200 may move (move forward) in the axial direction, and the load when the driver bit 2 moves (moves forward) in the axial direction decreases. Accordingly, the movement amount along the axial direction of the driver bit 2 may follow the movement amount along the axial direction of the screw 200 when the screw 200 is fastened to the steel sheet 203 by rotation, and the rotation speed of the bit movement motor 50 increases. Therefore, by releasing the limitation on the current flowing to the bit movement motor 50, in the screw fastening section E2, the driver bit 2 may follow the screw 200 fastened to the fastening target 202 and the steel sheet 203, and the screw 200 may be fastened to the fastening target 202 and the steel sheet 203.

When it is determined in step SC14 that the rotation amount of the bit movement motor 50 becomes the setting value selected by the setting portion 110 and the tip of the driver bit 2 reaches the set operation end position, the controller 100 stops the driving of the bit rotation motor 40 in step SC15 at the timing T5 when the driver bit 2 moves by the defined amount shown in FIG. 13, stops the rotation in the forward direction of the bit movement motor 50 in step SC16, and then reversely rotates the bit movement motor 50 in step SC17.

When the holding member 30 and the moving member 32 move in the rear direction to the position where the tip of the driver bit 2 returns to the standby position P1 in step SC18, the controller 100 stops the reverse rotation of the bit movement motor 50 in step SC19.

When it is determined that the rotation speed V2 of the bit movement motor 50 does not fall below the high-load deceleration threshold value S and the reduction amount of the rotation speed of the bit movement motor 50 is within the normal deceleration range in the process in which the rotation speed V2 of the bit movement motor 50 decreases after the load generation timing T1, the controller 100 determines that the screw 200 is fastened to the normal fastening target 202 such as wood or gypsum, and continues the first load control.

In a case where the controller is in the first control mode, when the screw engaged with the driver bit is fastened to the fastening target and the controller determines that the movement speed of the bit holding portion is decreased, the controller may further decrease the movement speed of the bit holding portion, and in a case where the controller is in the second control mode, when the screw engaged with the driver bit is fastened to the fastening target and the controller determines that the movement speed of the bit holding portion is equal to or lower than a predetermined speed, the controller may further decrease the movement speed of the bit holding portion. After further decreasing the movement speed of the bit holding portion, the controller may increase the movement speed of the bit holding portion within a range less than a first movement speed of the bit holding portion before the movement speed of the bit holding portion is further decreased. Also, after further decreasing the movement speed of the bit holding portion and then determining that the movement speed of the bit holding portion is increased, the controller may restore the movement speed of the bit holding portion to the first movement speed. The controller may be configured to decrease the movement speed of the bit holding portion in a case where the reduction amount of the rotation speed of the first motor is reduced when the screw engaged with the driver bit is fastened to the fastening target. Also, the controller may be configured to increase the movement speed of the bit holding portion in a case where the reduction amount of the rotation speed of the first motor increases after the reduction amount is decreased when the screw engaged with the driver bit is fastened to the fastening target.

What is claimed is:

1. A fastening tool comprising:
a bit holding portion configured to hold a driver bit engageable with a screw and rotatable in a circumferential direction of the driver bit and movable in an axial direction of the driver bit;
a motor configured to move the bit holding portion in the axial direction;
a controller configured to control output of the motor to control a movement speed of the bit holding portion in the axial direction; and
a motor state detector configured to detect a state of the motor, wherein
the controller is configured to control the movement speed of the bit holding portion based on the state of the motor when the screw engaged with the driver bit is fastened to a fastening target.

2. The fastening tool according to claim 1, wherein
the state of the motor is a rotation speed of the motor.

3. The fastening tool according to claim 2, wherein
the controller is configured to decrease the output of the motor in a case where the movement speed of the bit holding portion is equal to or lower than a predetermined speed when the screw engaged with the driver bit is fastened to the fastening target.

4. The fastening tool according to claim 3, wherein
after decreasing the output of the motor, the controller increases the movement speed of the bit holding portion within a range less than a first movement speed of the bit holding portion before the output of the motor is decreased.

5. The fastening tool according to claim 4, wherein
after decreasing the output of the motor and then determining that the movement speed of the bit holding portion is increased, the controller restores the movement speed of the bit holding portion to the first movement speed.

6. The fastening tool according to claim 2, further comprising:
a mode switch portion configured to switch a control mode of the controller between a first control mode and a second control mode, wherein
in a case where the controller is in the first control mode, when the screw engaged with the driver bit is fastened to the fastening target and the controller determines that the movement speed of the bit holding portion is decreased, the controller decreases the output of the motor, and
in a case where the controller is in the second control mode, when the screw engaged with the driver bit is fastened to the fastening target and the controller determines that the movement speed of the bit holding portion is equal to or lower than a predetermined speed, the controller decreases the output of the motor.

7. The fastening tool according to claim 6, wherein
after decreasing the output of the motor, the controller increases the movement speed of the bit holding portion within a range less than a first movement speed of the bit holding portion before the output of the motor is decreased.

8. The fastening tool according to claim 6, wherein
after decreasing the output of the motor and then determining that the movement speed of the bit holding portion is increased, the controller restores the movement speed of the bit holding portion to the first movement speed.

9. A fastening tool comprising:
a bit holding portion configured to hold a driver bit engageable with a screw and rotatable in a circumferential direction of the driver bit and movable in an axial direction of the driver bit;
a first motor configured to rotate the bit holding portion in the circumferential direction;
a second motor configured to move the bit holding portion in the axial direction;
a controller configured to control output of the first motor to control a rotation speed of the bit holding portion, and control output of the second motor to control a movement speed of the bit holding portion; and
a first motor state detector configured to detect a state of the first motor, wherein
the controller is configured to control the movement speed of the bit holding portion based on the state of the first motor detected by the first motor detector when the screw engaged with the driver bit is fastened to a fastening target.

10. The fastening tool according to claim 9, wherein
the state of the first motor is a rotation speed of the first motor.

11. The fastening tool according to claim 10, wherein
the controller is configured to control the movement speed of the bit holding portion based on a reduction amount of the rotation speed of the first motor when the screw engaged with the driver bit is fastened to the fastening target.

12. The fastening tool according to claim 11, wherein
the controller is configured to decrease output of the second motor in a case where the reduction amount of the rotation speed of the first motor is reduced when the screw engaged with the driver bit is fastened to the fastening target.

13. The fastening tool according to claim 12, wherein
the controller is configured to increase the output of the second motor in a case where the reduction amount of the rotation speed of the first motor increases after the reduction amount is decreased when the screw engaged with the driver bit is fastened to the fastening target.

14. The fastening tool according to claim 13, wherein
the controller is configured to execute lead advance angle control for the first motor.

15. The fastening tool according to claim 14, wherein
the controller is configured to execute the lead advance angle control for the first motor after decreasing the movement speed of the bit holding portion.

16. The fastening tool according to claim 1, wherein
the controller is configured to further decrease the movement speed of the bit holding portion in a case where the movement speed of the bit holding portion is equal to or lower than a predetermined speed when the screw engaged with the driver bit is fastened to the fastening target.

17. The fastening tool according to claim 16, wherein
after further decreasing the movement speed of the bit holding portion, the controller is configured to increase the movement speed of the bit holding portion within a range less than a first movement speed of the bit holding portion before the movement speed of the bit holding portion is decreased.

18. The fastening tool according to claim 16, wherein
after further decreasing the movement speed of the bit holding portion and then determining that the movement speed of the bit holding portion is increased, the controller restores the movement speed of the bit holding portion to the first movement speed.
